(19) United States
(12) Patent Application Publication
(10) Pub. No.: US 2025/0111684 A1
(43) Pub. Date: Apr. 3, 2025

(54) CELL INFORMATION ACQUISITION METHOD, CELL MANUFACTURING METHOD, CELL INSPECTION METHOD, CELL ABNORMALITY DETECTION METHOD, CELL INFORMATION ACQUISITION APPARATUS, AND NON-TRANSITORY RECORDING MEDIUM

(71) Applicants: CANON KABUSHIKI KAISHA, Tokyo (JP); CANON MEDICAL SYSTEMS CORPORATION, Tochigi (JP)

(72) Inventors: Shuhei TOBA, Kanagawa (JP); Yoji YAMAMOTO, Tokyo (JP); Yukiteru MASUDA, Kanagawa (JP)

(21) Appl. No.: 18/895,444

(22) Filed: Sep. 25, 2024

(30) Foreign Application Priority Data
Sep. 28, 2023 (JP) 2023-168648

(51) Int. Cl. G06V 20/69; G06T 7/00; G06V 10/26; G06V 10/50; G06V 10/77

(52) U.S. Cl. CPC G06V 20/698; G06T 7/0012; G06V 10/26; G06V 10/50; G06V 10/77; G06V 20/695; G06T 2207/20021; G06T 2207/20081; G06T 2207/30024

(57) ABSTRACT

Provided is a cell information acquisition method including: an image acquisition step of acquiring a cell image; a cell region extraction step of extracting a cell region from the cell image; a first feature value distribution acquisition step of calculating a texture feature value serving as a first feature value for pixels within the cell region, and acquiring a distribution of the first feature value in the cell region; a region division step of dividing the cell region into two or more divided regions; a second feature value calculation step of calculating a second feature value indicating a relationship of a statistical values of the first feature value distribution among the divided regions; and a cell information acquisition step of acquiring one of information about a cell type or a state of a cell based on the second feature value.

### BACKGROUND OF THE INVENTION

### Field of the Invention

The disclosure of the present specification relates to a cell information acquisition method, a cell manufacturing method, a cell inspection method, a cell abnormality detection method, a cell information acquisition apparatus, and a non-transitory recording medium.

### Description of the Related Art

In recent years, in the field of cell culture, it has been expected to analyze an image of a cell to be cultured, to thereby acquire cell information such as a cell line type and a state of a colony and utilize the cell information for quantitative analysis regarding a state of the cell and for inspection in cell culture.

As a specific method for cell image analysis, there has been proposed a method in which image feature values including a size, a shape, and a texture feature of a colony are extracted from a picked-up image of the colony to be used in statistical analysis and machine learning.

For example, in Japanese Patent No. 5941674, a technology of calculating a local texture feature value of a cell region is disclosed.

In addition, colonies are known to exhibit characteristics of cells that differ from each other within each colony region. Accordingly, it is also important to calculate not only a feature value of an entire cell region but also a feature value reflecting the difference in characteristics depending on the region.

In Japanese Patent Application Laid-Open No. 2016-007270, a technology of dividing a region into partial regions and calculating a feature value in each partial region is disclosed.

However, while the technology as described in Japanese Patent Application Laid-Open No. 2016-007270 can evaluate, through feature values, differences in characteristics between the respective partial regions, it cannot be said that the technology is an image analysis method sufficient for evaluating a cell type or a state of a cell for an entire cell region based on differences in feature values between the partial regions.

### SUMMARY OF THE INVENTION

In view of the above-described problem, the present invention has an object to provide a cell information acquisition method capable of evaluating a cell type or a state of a cell for an entire cell region.

According to one aspect of the disclosure of the present specification, there is provided a cell information acquisition method including: an image acquisition step of acquiring a cell image including an image of a cell aggregation; a cell region extraction step of extracting at least one cell region from the cell image data, where each cell region corresponds to an aggregate; a first feature value distribution acquisition step of calculating a texture feature value serving as a first feature value for pixels within the cell region, and acquiring a distribution of the first feature value in the cell region; a region division step of dividing the cell region into two or more divided regions; a second feature value calculation step of calculating the statistical value of the first feature value distribution for each divided region, and calculating a second feature value indicating a relationship of the statistical values of the first feature value distribution among the divided regions; and a cell information acquisition step of acquiring one of information about a cell type or a state of a cell based on the second feature value.

Further, according to another aspect of the disclosure of the present specification, there is provided a cell manufacturing method including: a cell state information acquisition step of acquiring the information about a state of a cell through use of the above-described cell information acquisition method; and a cell processing step of carrying out at least any one selected from the group consisting of sorting of a cell, removal of a cell, and transition to a subsequent step in cell manufacturing, based on the information about the state of the cell acquired in the cell state information acquisition step.

Further, according to still another aspect of the disclosure of the present specification, there is provided a cell inspection method including: a cell state information acquisition step of acquiring the information about a state of a cell through use of the above-described cell information acquisition method; and a cell inspection step of carrying out inspection of the cell based on the information about the state of the cell acquired in the cell state information acquisition step.

Further, according to yet another aspect of the disclosure of the present specification, there is provided a cell abnormality detection method including: an image acquisition step of acquiring a cell image including an image of a cell aggregation; a cell region extraction step of extracting at least one cell region from the cell image data, where each cell region corresponds to a cell aggregate; a first feature value distribution acquisition step of calculating a texture feature value serving as a first feature value for pixels within the cell region, and acquiring a distribution of the first feature value in the cell region; a region division step of dividing the cell region into two or more divided regions; a second feature value calculation step of calculating the statistical value of the first feature value distribution for each divided region, and calculating a second feature value indicating a relationship of the statistical value of the first feature value distribution among the divided regions; a trained model acquisition step of acquiring a trained model that has machine-learned a probability of occurrence of the second feature value through use of a data group of the second feature values obtained from a plurality of the cell images prepared for machine learning; an abnormality score calculation step of inputting, to the trained model, the second feature value obtained from the cell image to be evaluated, and calculating an abnormality score based on an output probability; and a detection step of detecting an abnormality of the cell aggregation based on the abnormality score.

Further, according to yet another aspect of the disclosure of the present specification, there is provided a cell information acquisition apparatus including: an image acquisition unit configured to acquire a cell image including an image of a cell aggregation; a cell region extraction unit configured to extract at least one cell region from the cell image data, where each cell region corresponds to a cell aggregate; a first feature value distribution acquisition unit configured to calculate a texture feature value serving as a first feature value for pixels within the cell region, and acquire a distribution of the first feature value in the cell region; a region division unit configured to divide the cell region into two or more divided regions; a second feature value calculation unit configured to calculate the statistical value of the first feature value distribution for each divided region, and calculate a second feature value indicating a relationship of the statistical value of the first feature value distribution among the divided regions; and a cell information acquisition unit configured to acquire one of information about a cell type or a state of a cell based on the second feature value.

Further, according to yet another aspect of the disclosure of the present specification, there is provided a non-transitory recording medium having stored thereon a program for causing a computer to execute one of the above-described cell information acquisition method or the above-described cell abnormality detection method.

Further features of the present invention will become apparent from the following description of exemplary embodiments with reference to the attached drawings.

### BRIEF DESCRIPTION OF THE DRAWINGS

FIG. 1 is a function block diagram of a cell information acquisition apparatus according to a first embodiment.

FIG. 2 is a flow chart of a cell information acquisition method according to the first embodiment.

FIG. 3 is a flow chart for illustrating a method of extracting cell regions.

FIG. 4 is a diagram for illustrating an example of the extracted cell regions.

FIG. 5 is a function block diagram of a cell information acquisition apparatus according to a third embodiment.

FIG. 6 is a flow chart of a cell information acquisition method according to the third embodiment.

FIG. 7 is a function block diagram of a cell abnormality detection apparatus according to a fourth embodiment.

FIG. 8 is a flow chart of a cell abnormality detection method according to the fourth embodiment.

FIG. 9 is a block diagram for illustrating a hardware configuration of an information processing apparatus.

FIG. 10A is a box plot for showing a distribution of a second feature value for each cell line out of results obtained in Example 1.

FIG. 10B is a table for showing output results of an F-value and a P-value in analysis of variance out of the results obtained in Example 1.

FIG. 11A is a box plot for showing a distribution of an average value of a texture feature value of an entire cell region for each cell line out of results obtained in Comparative Example 1.

FIG. 11B is a table for showing output results of an F-value and a P-value in analysis of variance out of the results obtained in Comparative Example 1.

FIG. 12 is a scatter plot for showing analysis results of principal component analysis obtained in Example 2.

FIG. 13 is a scatter plot for showing analysis results of principal component analysis obtained in Comparative Example 2.

### DESCRIPTION OF THE EMBODIMENTS

Now, embodiments are described in detail with reference to the accompanying drawings. The embodiments described below do not limit the invention defined in the claims. A plurality of features are described in the embodiments, but the invention does not necessarily require all of those plurality of features, and a plurality of features may be combined as appropriate. Further, in the accompanying drawings, the same or similar components are denoted by the same reference symbols, and redundant description thereof is omitted.

### First Embodiment

In a first embodiment, a method involving dividing an inside of each cell region and calculating a new feature value based on a result of the division is described by taking a stem cell as a favorable example of a cell that forms a cell colony (hereinafter simply referred to as “colony”) serving as a basis for extracting a cell region. Examples of the stem cell that can be used include an induced pluripotent stem cell (iPS cell), which is a pluripotent stem cell, an embryonic stem cell (ES cell), and a mesenchymal stem cell, which is a tissue stem cell. Colonies in the present embodiment refer to communities each of which is made up of cells that are present in contact with one another (hereinafter simply referred to as “cell communities”), and each of which is an independent presence in a culture vessel. That is, a cell aggregate unbonded to other surrounding cell communities is regarded as one colony.

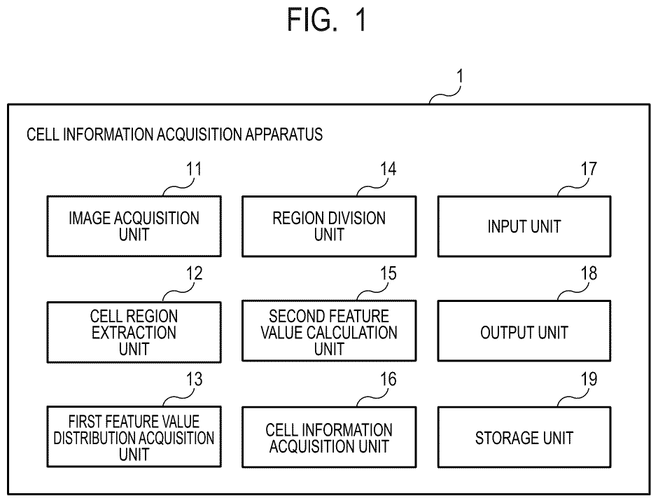

FIG. 1 is an illustration of a configuration example of an apparatus for carrying out a cell information acquisition method according to the first embodiment.

A cell information acquisition apparatus 1 includes an image acquisition unit 11, a cell region extraction unit 12, a first feature value distribution acquisition unit 13, a region division unit 14, a second feature value calculation unit 15, a cell information acquisition unit 16, an input unit 17, an output unit 18, and a storage unit 19.

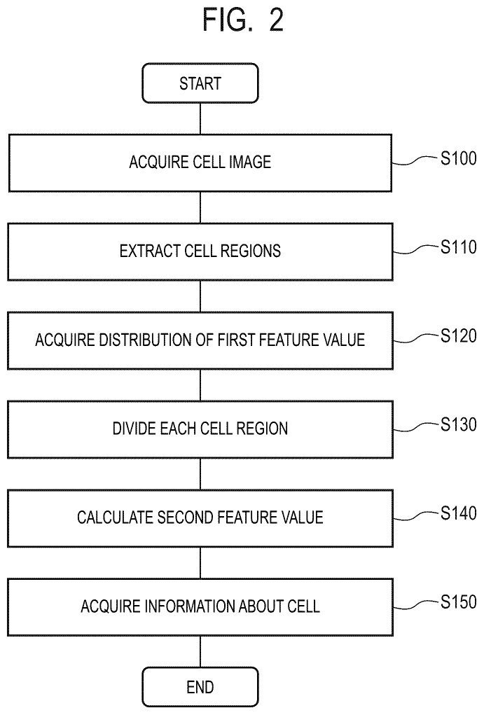

FIG. 2 is a flow chart of the cell information acquisition method according to the first embodiment.

### (Step S100: Cell Image Acquisition)

Step S100 is an image acquisition step of acquiring, by the image acquisition unit 11, an image of a cell aggregation.

In the present embodiment, the cell aggregation described above is a colony formed by culturing a stem cell.

In Step S100, the image acquisition unit 11 acquires cell image data photographed by a cell culture observation apparatus. In this case, the cell image is image data indicating a form of a cell. The image data indicating the form of a cell is, for example, phase difference image data photographed by a phase contrast microscope.

The cell image to be acquired in the present step is not limited to the phase difference image data, and may be any image as long as the cell image has a feature in which contrast of a contour portion of a cell is emphasized with respect to a non-cell region. For example, an image picked up in a differential interference optical system, an image picked up in an oblique illumination system, an image picked up in an optical system in which an object side and an image side are telecentric (both-side telecentric optical system), a defocused image, or the like can be used as a cell image. The cell information acquisition method according to the present embodiment is favorably applicable to the images exemplified above. The “defocused image” refers to a bright-field image photographed by shifting from the in-focus position by a fixed distance in the optical-axis direction.

Further, the cell image is preferred to be an image photographed at a timing at which a colony of a sufficient size is formed. For example, in a case of a cultured cell in a process of culturing an iPS cell maintaining an undifferentiated state, an image is acquired at a timing of the seventh day after seeding.

The cell image data may be acquired in real time from the cell culture observation apparatus, or may be acquired from an external storage area such as the storage unit 19 or cloud storage.

### (Step S110: Cell Region Extraction)

Step S110 is a cell region extraction step of extracting, by the cell region extraction unit 12, cell regions each indicating a region of a cell aggregation from the cell image acquired in Step S100.

For the extraction of a cell region in a phase difference image, image processing or a publicly known image analysis technology based on machine learning can be used. For example, the cell regions are extracted by a differential filter and through binarization processing.

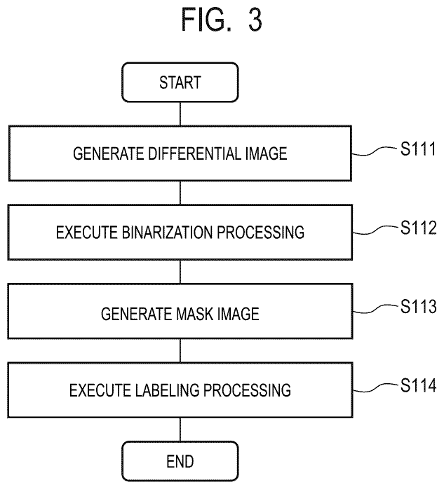

FIG. 3 is a flow chart for illustrating a flow of extracting cell regions by a differential filter and through binarization processing as an example of the processing of Step S110. In the following description, a method of extracting cell regions is described with reference to FIG. 3.

In Step S111, a differential image is generated by applying a differential filter to one cell image. The differential image is obtained by calculating, for each pixel, an amount of change in luminance value between the pixel and surrounding pixels, and expressing calculated amounts of change as an image. The differential image is an image that has large amounts of change in luminance value in contour portions of cell regions and contour portions of cells within the cell regions.

In Step S112, regions having large amounts of change in luminance value in the differential image are extracted by performing binarization processing on the differential image generated in Step S111. In the binarization processing, any threshold value is set, and a value of an amount of change in luminance value for each pixel of the differential image is replaced with 1 when the value is equal to or more than the threshold value, and with 0 when the value is less than the threshold value.

How the binarization processing is executed is not limited to the method in which any threshold value is set. For example, a method of automatically determining a threshold value such as Otsu's binarization or binarization by Li's algorithm may be used. In a case of setting any threshold value, the threshold value is set so as to suit photographing conditions of the apparatus such as the length of exposure to light and focus settings. A method of determining a threshold for each pixel of an image such as adaptive binarization may also be used. Through the binarization processing, a binary image expressed by setting 1 to pixel values in a region in which a value of an amount of change in luminance value is large and 0 to pixel values in other regions (hereinafter referred to as “edge image”) is created.

In Step S113, a mask image of cell regions is generated based on the edge image generated in Step S112. Here, the mask image is a binary image in which cell regions are expressed by a pixel value of 1 and other regions are expressed by a pixel value of 0. The mask image is generated by extracting regions to which a pixel value of 1 is linked in the edge image, and replacing the pixel values inside each linked region with 1.

In Step S114, a label image in which individual cell regions are discriminated from each other is generated by performing labeling processing on the mask image generated in Step S113. In the labeling processing, regions to which a pixel value of 1 is linked in the mask image are extracted, and, for each linked region, operation of replacing values of pixels in that region with pixel values different from one another is performed.

A threshold value for the size of a cell region may be set to exclude cell regions of sizes smaller than the threshold value. For example, an area of 10,000 μm² is set as the threshold value in the case of a stem cell. In labeling of each linked component of the mask image, the area of the linked region is calculated, and the pixel value of that linked region is set to 0 when the area is equal to or less than the threshold value.

The processing steps of from Step S111 to Step S114 described above are executed, and cell regions in each of the cell images are thus extracted.

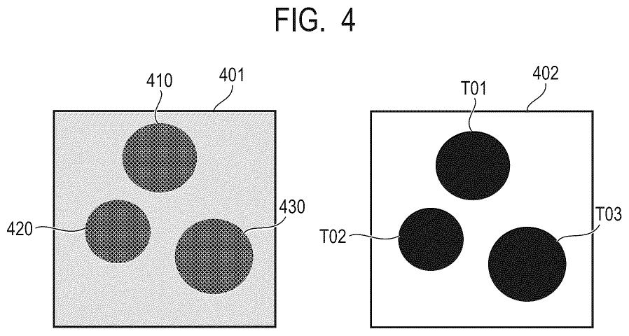

An example of extracting cell regions from a cell image 401 is illustrated in FIG. 4. The cell image 401 includes three cell regions 410, 420, and 430. A mask image 402 is the image generated in Step S113, and uses a white color to indicate a background region and a black color to indicate cell regions. The labeling processing in Step S114 is performed on the mask image, with the result that isolated individual cell regions such as cell regions T01, T02, and T03 illustrated in FIG. 4 are discriminated from one another. The cell regions can thus be extracted.

In the extraction, in a case in which a cell region is in contact with the outer circumference of the culture vessel or of an image pickup field, it is preferred to exclude such a cell region. Whether a cell region is in contact with the outer circumference of the culture vessel is determined by setting a contour that indicates the culture vessel in advance, or extracting the contour of the culture vessel through Hough transform or a similar method, and determining whether a cell region overlaps with the contour. Similarly, whether a cell region is in contact with the outer circumference of the image pickup field is determined by determining whether a cell region overlaps with the outer circumference of the picked-up image.

Through the present step, a mask image in which individual cell regions independent of each other can be discriminated through the labeling processing and contour coordinate information corresponding to the individual cell regions are acquired as information indicating a plurality of cell regions.

### (Step S120: First Feature Value Distribution Acquisition)

Step S120 is a first feature value distribution acquisition step of calculating, by the first feature value distribution acquisition unit 13, a texture feature value serving as a first feature value for each pixel in each cell region, and acquiring a distribution of the first feature value in the cell region.

The distribution of the first feature value can be calculated by calculating the texture feature value of a small region centered on any pixel position in the cell region in the cell image and repeating mapping to the same pixel position for all pixels in the cell region. The texture feature value serving as the first feature value is not always required to be mapped to all the pixels, but the texture feature value being mapped to a larger proportion of pixels is preferred because a result of higher accuracy is obtained when a proportion (density) of pixels to which the texture feature value is mapped becomes higher.

The texture feature value is a scalar value calculated based on a luminance distribution of an image, and a contrast is calculated by, for example, a texture analysis method utilizing a gray level co-occurrence matrix (GLCM). The contrast is an example of the texture feature value calculated by the texture analysis method utilizing the GLCM, and the texture feature value is not limited to the contrast, and may be a feature value such as an entropy, uniformity, or non-uniformity.

A size of the small region in which the texture feature value is calculated is preferred to be that of a region in which a fixed number of cells are included. For example, when a diameter size of one cell in the acquired cell image is equivalent to 8 pixels, a square region having one side of 128 pixels is set as the small region.

Through the present step, a distribution of the first feature value corresponding to each of the cell regions acquired in Step S110 is acquired.

### (Step S130: Region Division)

Step S130 is a region division step of dividing, by the region division unit 14, the cell region into two or more divided regions.

In a colony-forming cell such as an iPS cell, a plurality of regions in a colony region that are formed of cell groups different in morphological characteristics or functional characteristics of the cell may be further generated (this phenomenon is hereinafter referred to as “domain formation”). For example, in a colony to which a pluripotent stem cell has grown, a cell density of an inner-side region of the colony may be higher than that of an outer-side region of the colony. As another example, in observation of staining through use of an undifferentiated marker, strong marker expression may be observed in an outer-side region of the colony. The domain formation may also be observed, for example, in a case in which a cell differentiated from a stem cell is partially generated in a colony due to poor culture, or in a case in which a colony derived from a plurality of cells is formed.

Thus, in the present step, it is desired to divide the region so that differences in characteristics within the colony region are reflected.

In the present embodiment, each of the cell regions extracted in Step S110 is divided into two regions, that is, an inner region and an outer-edge region, based on the area of the cell region in Step S130. Specifically, each of the cell regions acquired in Step S110 is subjected to contraction processing, to thereby be divided into the inner region and the outer-edge region. At this time, the contraction processing is carried out so that an area ratio between the inner region and the outer-edge region becomes a ratio determined in advance. For example, the contraction processing is performed so that an area ratio between the inner region and the outer-edge region is 1:1.

A distance image may be used to divide the cell region into two regions, that is, the inner region and the outer-edge region. The distance image is an image in which each pixel value in a cell region is replaced by a value obtained by calculating a distance from a center-of-gravity of the cell region to a contour thereof. Specifically, a distance image is first generated for each of the cell regions acquired in Step S110. At this time, the calculated value of the distance is assumed to be normalized so that a maximum value is 1.0 and a minimum value is 0.0 in each cell region. A threshold value is set for pixel values of each generated distance image so that pixel values less than the threshold value indicate the inner region and pixel values equal to or more than the threshold value indicate the outer-edge region, to thereby enable the cell region to be divided into two regions, that is, the inner region and the outer-edge region. The threshold value is set to, for example, 0.5.

Through the present step, a divided region is created for each of the cell regions acquired in Step S110.

### (Step S140: Second Feature Value Calculation)

Step S140 is a second feature value calculation step of calculating, by the second feature value calculation unit 15, the statistical value of the first feature value distribution for each divided region and calculating a second feature value indicating a relationship of the statistical value of the first feature value distribution among the divided regions.

Specifically, for each cell region, the statistical value of the first feature value distribution in the inner region obtained through the division in Step S130 and the statistical value of the first feature value distribution in the outer-edge region are calculated, and a ratio therebetween is calculated as the second feature value. For example, an average value is calculated as the statistical value.

The statistical value is not limited to the average value, and may be any one of other types of statistical value such as a median value, a standard deviation, and a coefficient of variation (CV value), or a feature value vector corresponding to one cell region by calculating a plurality of types of second feature values through use of a plurality of types of statistical value. In the following description, even a feature value vector obtained by calculating a plurality of types of second feature values is simply referred to as “second feature value.”

Through the present step, the second feature value expressing a degree of change in luminance characteristic between the inner region and the outer-edge region is further calculated for each of the cell regions.

### (Step S150: Cell Information Acquisition)

Step S150 is a cell information acquisition step of acquiring, by the cell information acquisition unit 16, information about a cell type or a state of a cell based on the second feature value.

The information about the cell type acquired in the information acquisition step of Step S150 is not limited to classification by biological cell type, and includes, for example, information about a cell line type (that differs in origin of a cell, a manufacturing lot, a clone, or the like) in the same cell type.

Examples of the information about the state of the cell include information about cell quality and a disease, such as viability, proliferation, a degree of undifferentiation, residual states of a foreign gene and a reprogramming factor for iPS cell formation, presence or absence of a karyotype abnormality or a genomic abnormality, production efficiency of a useful substance, and presence or absence of cancerous transformation. The information about the state of the cell also includes information about whether transition to the subsequent step such as culture medium replacement, cell harvesting, or differentiation induction is appropriate or inappropriate in cell manufacturing.

It is preferred to acquire the information about the cell type or the information about the state of the cell in combination with comparison of a plurality of different kinds of cultured cell observation in a second embodiment or analysis using a trained model in a third embodiment, which are described later.

In the present embodiment, an example in which the number of the cell regions to be extracted in the cell region extraction step is three or more and the cell region extraction step includes acquiring, by the cell information acquisition unit 16, a clustering result of clustering the cell regions into two or more clusters is described.

In Step S150, the cell information acquisition unit 16 uses the second feature value corresponding to each of the plurality of cell regions acquired in Step S140 to acquire an analysis result obtained through unsupervised clustering as information about the state of the cell.

As an example of a method for the unsupervised clustering, k-means with the number of clusters set to 2 is used. As the number of clusters, any numerical value may be allowed to be set by a user, or the number of clusters that are likely to be obtained may be automatically determined based on an evaluation index for the clustering result, such as AIC or BIC.

The method for the unsupervised clustering is not limited to k-means, and other clustering methods such as hierarchical clustering and mixed Gaussian distribution may also be used, or clustering based on a plurality of methods may be carried out to acquire respective results.

Through the present step, the cell regions are each classified based on the second feature value, and information indicating a classification result of each of the cell regions is acquired as cell information.

As the analysis result, for example, a graph in which the second feature value of each cell region is color-coded in accordance with the classification result may be output. In another case, the analysis result may be displayed in a format in which a contour line indicating each cell region is superimposed on the cell image acquired in Step S100 by being color-coded in accordance with the classification result.

With the cell information acquisition method according to the present embodiment, it is possible to acquire a more appropriate analysis result by dividing the inside of each colony region and calculating a new feature value based on a result of the division.

The present embodiment is favorably applicable also to a case in which a plurality of cell images have been acquired, such as a case in which a plurality of cell images of a plurality of fields have been photographed in observation of cultured cells. In that case, Step S110 to Step S140 are applied to each of the cell images to calculate the second feature value for each cell region of each of the cell images, and then the analysis of Step S150 is carried out.

### Modification Example 1 of First Embodiment: Texture Feature Value Based on Frequency Analysis

In the first embodiment, the example in which the contrast is calculated by the texture analysis method utilizing the GLCM as the texture feature value in Step S120 has been described, but the texture feature value to be calculated is not limited to the one based on the method utilizing the GLCM. For example, in Step S120, the texture feature value may be a feature value calculated by a method of analyzing a spatial frequency characteristic. For example, a target small region is converted into a spatial frequency by Fourier analysis, and then an average value of a power spectrum in a specific frequency band is set as the texture feature value. The specific frequency band is preferred to be such a band as to include a frequency corresponding to the cell diameter size, and a frequency band corresponding to, for example, 12 μm to 24 μm is set.

The feature value based on the method of analyzing the spatial frequency characteristic can be favorably used, for example, for such a cell type as to form a colony, such as a colony of an iPS cell, having a luminance distribution with a periodic pattern.

The processing steps of Step S130 and the subsequent steps are the same as those in the first embodiment.

Both the texture feature value distributions based on the GLCM and the frequency analysis may be calculated. In that case, in Step S140, second feature values are calculated through use of the respective texture feature value distributions, and are integrated to obtain a feature value vector as the second feature value.

With a cell information acquisition method according to the present modification example, when the colony is of such a cultured cell as to have domains formed of cells having different morphological features in the colony, a more appropriate analysis result can be acquired.

### Modification Example 2 of First Embodiment: Region Division Using Feature Value Distribution

In the first embodiment, the method of dividing each cell region into two regions, that is, the inner region and the outer-edge region, based on the area or the distance image of the cell region in Step S130 has been described. The method of dividing the region in Step S130 is not limited thereto, and the region may be divided in Step S130 based on the texture feature value distribution acquired in Step S120.

Specifically, a threshold value is set for the texture feature value acquired in Step S120, and the texture feature value distribution is divided into a region having a texture feature value less than the threshold value and a region having a texture feature value equal to or more than the threshold value. The threshold value is set to, for example, 0.5. In this case, each texture feature value in the texture feature value distribution is obtained by min-max normalization so as to fall within a range of from 0.0 to 1.0.

In addition, the texture feature value corresponding to each pixel position in the texture feature value distribution may be used as input data for an unsupervised clustering method to divide each region. For example, k-means with the number of clusters set to 2 is used.

The processing steps of Step S140 and the subsequent steps are the same as those in the first embodiment.

With a cell information acquisition method according to the present modification example, it is possible to acquire an appropriate analysis result by calculating a new feature value based on the texture feature value distribution and a result of dividing the inside of each cell region.

### Modification Example 3 of First Embodiment: Region Division into Three or More Regions

In the first embodiment or Modification Example 2 of the first embodiment, the example in which each cell region is divided into two regions and the second feature value is calculated therefor has been described, but the second feature value may be calculated by dividing the cell region into three or more regions.

Specifically, two types of threshold values “a” and “b” are set for the distance image in the first embodiment, to thereby divide each cell region into three regions. The threshold values “a” and “b” are set to, for example, 0.25 and 0.5, respectively, to thereby divide the cell region into three regions, that is, a region less than “a”, a region more than “a” and less than “b”, and a region equal to or more than “b”.

Further, as described in Modification Example 2 of the first embodiment, in the case of dividing the region based on the texture feature value distribution, the region may be divided by setting the number of clusters to three or more in the division of the region based on the unsupervised clustering.

In the first embodiment, the ratio between the statistical values of the texture feature values in two divided regions is calculated as the second feature value in Step S140, but in a case of division into three or more regions, the second feature value is set as follows. That is, an index indicating dispersion in statistical value of the texture feature values of respective divisions is calculated as the second feature value. The index indicating the dispersion is, for example, a variance, a standard deviation, or a coefficient of variation (CV value).

Further, a feature value vector, which is a set of scalar values obtained by carrying out calculation of a ratio between the statistical value of texture feature values in all combinations of two different regions out of the regions obtained through the division into three or more regions, may be set as the second feature value.

The processing steps of Step S150 and the subsequent steps are the same as those in the first embodiment, and descriptions thereof are accordingly omitted.

The present modification example is favorably applicable to analysis of cultured cells, such as iPS cells, in which a plurality of states such as a mature state and a differentiated or undifferentiated state of cells appear in the cell image to form complex domains.

### Modification Example 4 of First Embodiment: Use of Morphological Feature Value for Analysis

In Step S150, the information about the cell type or the state of the cell is acquired by the analysis using the second feature value, but a morphological feature value of each cell region may be further calculated to be used for the analysis.

Specifically, the cell information acquisition unit 16 calculates the morphological feature value from each cell region extracted in Step S110, and uses, for the analysis, a feature value vector obtained by integrating the morphological feature value with the second feature value calculated in Step S140. When the morphological feature value and the second feature value are integrated, the cell information acquisition unit 16 may acquire a result of performing principal component analysis.

In this case, the morphological feature value is, for example, a scalar value of any one of an area, a diameter, a circularity, a perimeter, a solidity, or a convexity, or a vector obtained by calculating a plurality of those values.

With a cell information acquisition method according to the present modification example, an appropriate analysis result can be acquired even in analysis of cultured cells in which a difference in morphological feature between cell regions is noticeably observed.

### Modification Example 5 of First Embodiment: Principal Component Analysis

The example of outputting an analysis result obtained by the method for the unsupervised clustering in Step S150 has been described. Further, in Step S150, when the feature value to be used for the analysis is a two- or more-dimensional feature value vector, the cell information acquisition unit 16 may acquire a result of analyzing, through principal component analysis, the two- or more-dimensional feature value vector including the second feature value.

At this time, two or more types of first feature values are calculated in the first feature value distribution acquisition step, and in the second feature value calculation step, the second feature value may be calculated for each of the first feature values. Further, as described in Modification Example 4, the morphological feature value of each cell region may be calculated for use in integration with the second feature value.

The principal component analysis is a statistical analysis method in which data having many variables is aggregated to create a principal component, and data represented by many variables (feature values) can be represented by fewer variables.

In the principal component analysis, a principal component being an element representing the feature of data, a principal component score indicating a numerical value in a principal component space of the feature value vector of input data, a principal component load amount indicating a degree of contribution of an element of an original feature value vector to each principal component, and the like are output.

When the analysis based on the principal component analysis is carried out, for example, a two-dimensional scatter plot in which a principal component score for a first principal component is set as a horizontal axis and a principal component score for a second principal component is set as a vertical axis is created and output. The principal component load amount may be displayed together.

According to the present modification example, when the feature value to be used for the analysis is a two- or more-dimensional feature value vector, the user can grasp which element of the feature value vector is important based on the principal component load amount, and can also grasp the feature of each cell region through the scatter plot from a wider viewpoint.

With a cell information acquisition method according to the present modification example, even when the feature value to be used for the analysis is a three- or more-dimensional feature value vector, it is possible to acquire an analysis result that can be easily grasped by the user.

It is also possible to use the principal component score of each cell region acquired in the present modification example as input to further carry out the unsupervised clustering in the first embodiment.

### Second Embodiment

In the first embodiment, the method of acquiring a cell image in any culture cell observation to acquire information about states of a plurality of cell regions has been described.

In the second embodiment, a method of acquiring a plurality of cell images different from one another to acquire information about a cell type or a state of a cell is described.

The “plurality of cell images different from one another” as used herein refer to, for example, cell images acquired in culture of a plurality of cell types different from one another, and the “plurality of cell types different from one another” refer to, for example, a cell line type of an iPS cell.

In the second embodiment, an example in which cell images acquired in culture of iPS cells having cell line types different from one another are used as the plurality of cell images different from one another is described, but the present embodiment is not limited thereto. For example, the present embodiment is favorably applicable also to cell images acquired in culture using culture vessels different from one another or to cell images acquired at photographing timings different from one another.

In Step S100, the image acquisition unit 11 acquires two or more cell images different from one another in response to a request of the user input from the input unit 17. For example, cell images of two types, that is, a cell line C01 and a cell line C02 of iPS cells are acquired. The cell images are each an image indicating a form of a cell in the same manner as in the first embodiment.

After that, the processing steps of from Step S110 to Step S140 are applied to the respective cell images of the cell line C01 and the cell line C02. Thus, a data group D01 of the second feature values corresponding to a plurality of cell regions in the cell line C01 and a data group D02 of the second feature values corresponding to a plurality of cell regions in the cell line C02 are acquired.

Details of the processing steps of from Step S110 to Step S140 are the same as those of the first embodiment, and descriptions thereof are accordingly omitted.

In this case, an identification ID is assigned to data of a cell region and second feature value data corresponding to the cell region so that it can be understood which cell image the data and the second feature value data were acquired from.

In the present embodiment, the cell information acquisition step of Step S150 includes statistically analyzing differences among the second feature values calculated from the respective two or more cell images.

Specifically, in Step S150, analysis based on a statistical test method is performed through use of the data groups D01 and D02 to output an analysis result. The statistical test method is, for example, a t-test, and a p-value obtained by the t-test is output as an analysis result. The statistical test method is not limited to the t-test, and an F-test or, in a case of three or more data groups, analysis of variance or a similar method can be used.

Further, information indicating statistical value of a data group or a graph that shows a data distribution, such as a box plot or a histogram, may be output together with the analysis result of the statistical test method.

When the second feature value is a feature value vector, the result may be output by calculating the analysis result for each element of the feature value vector.

Thus, the user can quantitatively grasp a degree of difference between cultured cells depending on cell line types such as the cell line C01 and the cell line C02.

As described above, with a cell information acquisition method according to the second embodiment, when at least two or more cell images different from one another are acquired, the user can quantitatively grasp a degree of difference between cells picked up in the cell image.

In the second embodiment, the example of acquiring information about differences between cell line types of cells has been described, but the information to be acquired from differences in the second feature value analyzed in the cell information acquisition step of Step S150 in the present embodiment is not limited thereto. For example, when the analysis is performed through use of two or more cell images acquired in a process of culturing cells of the same cell line type under different culture conditions, an influence of a difference in culture condition on cell culture can be evaluated as well.

It is also preferred to acquire a cell image serving as a control in advance through use of a culture cell sample controlled in an appropriate manner. From the degree of difference exhibited when comparison to the cell image serving as a control is performed, information that allows determination that no cross-contamination or misalignment between samples has occurred in a cell manufacturing facility can be acquired. It is also possible to acquire information that allows, for example, determination that a cell is being successfully cultured while maintaining a state as expected or determination as to whether transition to the subsequent step in cell manufacturing (culture medium replacement, cell harvesting, differentiation induction, or the like) is appropriate or inappropriate.

### Modification Example 1 of Second Embodiment: Principal Component Analysis

In the second embodiment, the example of outputting an analysis result obtained by the statistical test method in Step S150 has been described, but when the feature value to be used for the analysis is a two- or more-dimensional feature value vector as described in Modification Example 5 of the first embodiment, analysis based on the principal component analysis may be carried out.

When the analysis based on the principal component analysis is carried out, for example, a two-dimensional scatter plot which is color-coded in accordance with a data group and in which the principal component score for the first principal component is set as the horizontal axis and the principal component score for the second principal component is set as the vertical axis is created and output. The principal component load amount may be displayed together. Further, one data group may be regarded as one cluster, and results of evaluating aggregation within a cluster and discreteness between clusters may be output.

Thus, the user can grasp which element of the feature value vector is important based on the principal component load amount, and can also grasp the features of each cell region and the data group through the scatter plot from a wider viewpoint.

With a cell information acquisition method according to the present modification example, even when the feature value to be used for the analysis is a two- or more-dimensional feature value vector, it is possible to acquire an analysis result that can be easily grasped by the user.

### Third Embodiment

In the third embodiment, a method of carrying out analysis using a trained model that uses the second feature value as input to acquire information about a cell type or a state of a cell is described.

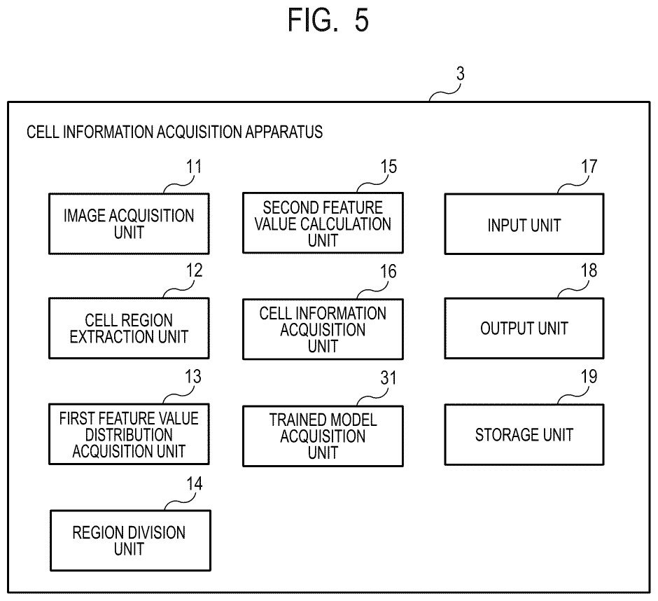

FIG. 5 is an illustration of a configuration example of an apparatus for carrying out a cell information acquisition method according to the third embodiment.

A cell information acquisition apparatus 3 further includes a trained model acquisition unit 31 in addition to the same components as those of the cell information acquisition apparatus 1.

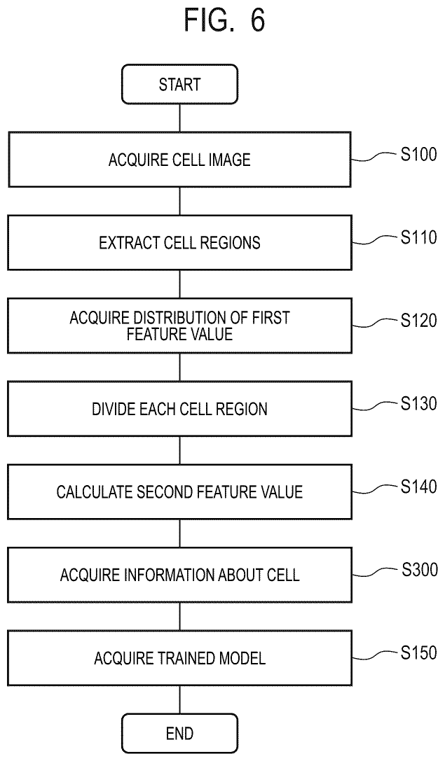

FIG. 6 is a flow chart of the cell information acquisition method according to the third embodiment.

Details of the processing steps of from Step S100 to Step S140 are the same as those of the first embodiment, and descriptions thereof are accordingly omitted.

Here, as described in the first embodiment or Modification Example 1 of the first embodiment, the second feature value may be a feature value vector obtained by integrating feature values calculated through a plurality of texture feature value distributions including the texture feature value distribution based on the analysis method utilizing the GLCM and the texture feature value distribution based on the frequency analysis.

Further, as described in Modification Example 4 of the first embodiment, the morphological feature value of the cell region may be integrated with the second feature value.

In a trained model acquisition step of Step S300, the trained model acquisition unit 31 acquires a trained model subjected to machine learning through use of the second feature value and the information about the cell type or the information about the state of the cell.

Here, the trained model is a machine learning model optimized to receive input of the second feature value data corresponding to cell regions and output a classification result indicating the cell type or the state of the cell for each of the cell regions. As the machine learning model, for example, a support vector machine (SVM) can be used. The machine learning model is not limited to the SVM, and a model such as a random forest or a neural network can be used.

The “classification result indicating the cell type or the state of the cell” as used herein refers to, for example, a result of classifying whether a colony in iPS cell culture is in an undifferentiated state or a differentiated state. The classification result is not limited to the result of classifying whether the colony is in an undifferentiated state or a differentiated state, and may be a result of classifying whether the colony includes a cell with an abnormal karyotype.

The cell information acquisition step of Step S150 includes using the trained model acquired in Step S300. That is, the cell information acquisition unit 16 sets the second feature value calculated in Step S140 as input to the trained model, to thereby acquire the information about the cell type or the information about the state of the cell. When there are a plurality of trained models, a result may be acquired from each of the trained models.

The trained model acquisition step of Step S300 may be preceded or followed by any one of Step S100 to Step S140 as long as the trained model acquisition step precedes Step S150.

In Step S150, information indicating whether a colony in iPS cell culture is in an undifferentiated state or a differentiated state is output as cell information.

When the information acquired in Step S150 is output from the output unit 18 to be checked, the user can check the information about the cell type or the state of the cell in each cell region.

As described above, with the cell information acquisition method according to the third embodiment, the information about the cell type or the state of the cell can be acquired through use of the trained model with the second feature value as input.

### Fourth Embodiment

In the third embodiment, the example in which the trained model that outputs the classification result indicating the cell type or the state of the cell is acquired in Step S300 has been described, but a trained model for abnormality detection may be acquired.

In the present embodiment, an example of a cell abnormality detection method using the trained model for abnormality detection is described.

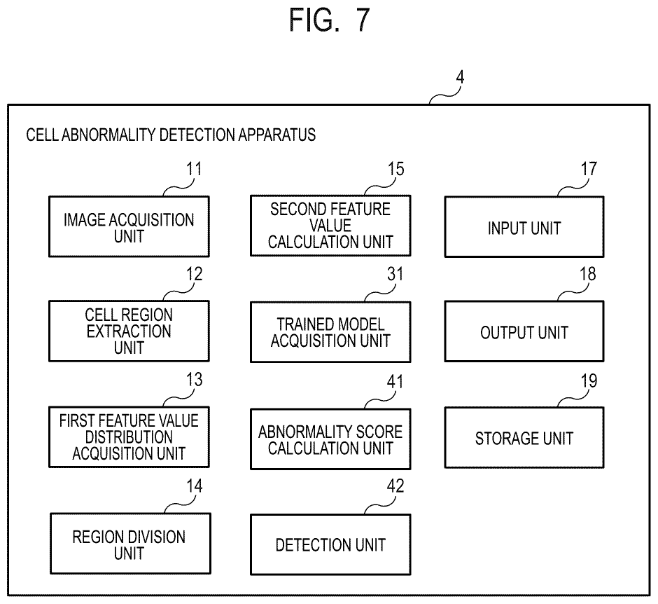

FIG. 7 is an illustration of a configuration example of an apparatus for carrying out the cell abnormality detection method according to the fourth embodiment.

A cell abnormality detection apparatus 4 includes an abnormality score calculation unit 41 and a detection unit 42 instead of the cell information acquisition unit 16 included in the cell information acquisition apparatus 3.

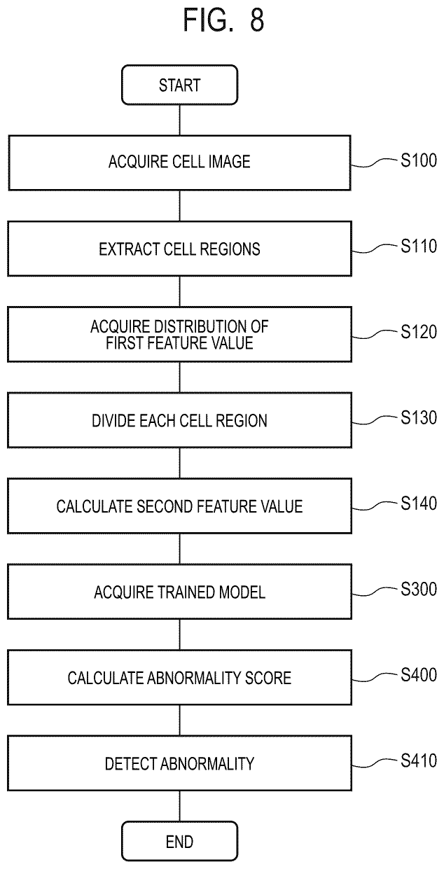

FIG. 8 is a flow chart of the cell abnormality detection method according to the fourth embodiment.

Details of the processing steps of from Step S100 to Step S140 are the same as those of the first embodiment, and descriptions thereof are accordingly omitted.

In the trained model acquisition step of Step S300, the trained model acquisition unit 31 acquires a trained model. Here, the trained model is a trained model that has machine-learned a probability of occurrence of a second feature value through use of a data group of the second feature values obtained from a plurality of cell images prepared for machine learning.

A probability of occurrence of the second feature value learned by the trained model in the present embodiment is estimated, for example, by a method such as kernel density estimation or mixed Gaussian distribution.

In an abnormality score calculation step of Step S400, the abnormality score calculation unit 41 inputs, to the trained model, the second feature value obtained from the cell image to be evaluated, and calculates an abnormality score based on an output probability. In this case, the abnormality score can be determined as appropriate in accordance with the output probability. For example, the abnormality score may be set to 0 when the probability is equal to or more than the predetermined threshold value and to 1 when the probability is less than the predetermined threshold value, or the inverse of the output probability may be set as the abnormality score.

As the trained model, for example, in a case of iPS cell culture, it is possible to use a trained model in which a data group of the second feature values of colonies in an undifferentiated state has been set as a training data group and which has been trained therewith. In this case, a scalar value indicating how far each iPS colony of the input deviates from the undifferentiated state is output as the abnormality score in the abnormality score calculation step. The trained model is not limited to the trained model in which the data group of the second feature values of colonies in an undifferentiated state has been set as the training data group and which has been trained therewith. For example, a trained model in which a data group of the second feature values of colonies including no cell with an abnormal karyotype has been set as the training data group and which has been trained therewith may be used. Further, when there are a plurality of trained models, a result from each thereof may be acquired.

In a detection step of Step S410, the detection unit 42 detects an abnormality of a cell based on the abnormality score. The abnormality of the cell detected by the detection unit 42 is output through the output unit 18.

The trained model acquisition step of Step S300 may be preceded or followed by any one of Step S100 to Step S140 as long as the trained model acquisition step precedes Step S150.

In the present embodiment, the example in which the trained model that has machine-learned the probability of occurrence of the second feature value is used has been described, but the combination is not limited thereto. For example, it is also possible to use a trained model that has machine-learned a probability of occurrence of a combination of the second feature value and another feature value, for example, the morphological feature value as described in Modification Example 4 of the first embodiment.

### Program for Causing Cell Information Acquisition Method to be Executed

A program according to the present invention is a program for causing a computer to execute the cell information acquisition method according to the present invention or the cell abnormality detection method according to the present invention that has been described above.

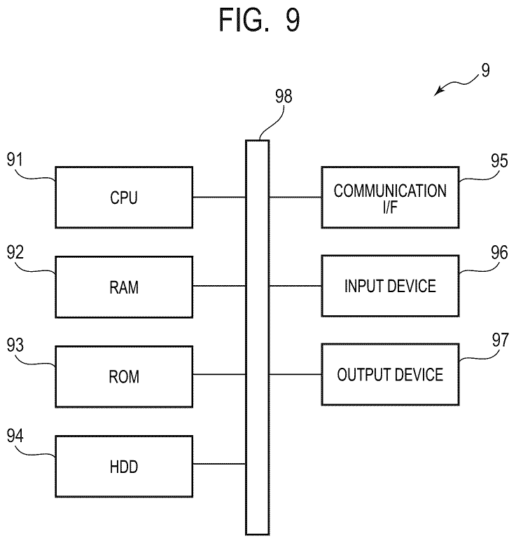

FIG. 9 is a block diagram for illustrating a hardware configuration example of an information processing apparatus 9 usable as any one of the cell information acquisition apparatus 1 and 3 and the cell abnormality detection apparatus 4.

The information processing apparatus 9 has functions of a computer. For example, the information processing apparatus 9 may be configured unitarily with a desktop personal computer (PC), a laptop PC, a tablet PC, or a smartphone, for example.

The information processing apparatus 9 includes, in order to implement functions as a computer which performs arithmetic operation and storage, a central processing unit (CPU) 91, a random-access memory (RAM) 92, a read-only memory (ROM) 93, and a hard disk drive (HDD) 94. The information processing apparatus 9 also includes a communication interface (I/F) 95, an input device 96, and an output device 97. The CPU 91, the RAM 92, the ROM 93, the HDD 94, the communication I/F 95, the input device 96, and the output device 97 are connected to each other via a bus 98. The input device 96 and the output device 97 may be connected to the bus 98 via a drive device (not shown) for driving those devices.

In FIG. 9, the various components forming the information processing apparatus 9 are illustrated as an integrated device, but a part of the functions of those components may be implemented by an external device. For example, the input device 96 and the output device 97 may be external devices different from the components implementing the functions of the computer including the CPU 91, for example.

The CPU 91 performs predetermined operations in accordance with programs stored in, for example, the RAM 92 and the HDD 94, and also has a function of controlling each component of the information processing apparatus 9. The RAM 92 is built from a volatile storage medium, and provides a temporary memory area required for the operations of the CPU 91. The ROM 93 is built from a non-volatile storage medium, and stores required information such as programs to be used for the operations of the information processing apparatus 9. The HDD 94 is a storage device which is built from a non-volatile storage medium, and which stores information on the number of individual independent separate compartments and positions thereof and fluorescence intensities, for example.

The communication I/F 95 is a communication interface based on a standard such as Wi-Fi (trademark) or 4G, and is a unit for communicating to and from another device. Examples of the output device 97 include a liquid crystal display and an organic light emitting diode (OLED) display that are used for displaying moving images, still images, characters, and the like, and a speaker used for outputting sound. Examples of the input device 96 include a button, a touch panel, a keyboard, and a pointing device, and the input device 96 is used by a user to operate the information processing apparatus 9. The input device 96 and the output device 97 may be integrally formed as a touch panel.

The hardware configuration illustrated in FIG. 9 is an example, and devices other than the illustrated devices may be added, or a part of the illustrated devices may be omitted. Further, a part of the devices may be substituted with another device having the same function. Moreover, a part of the functions may be provided by another device via a network, and the functions for implementing the embodiments may be shared and implemented by a plurality of devices. For example, the HDD 94 may be substituted with a solid state drive (SSD) which uses a semiconductor element such as a flash memory, or may be substituted with cloud storage.

The CPU 91 loads a program stored in, for example, the ROM 93 onto the RAM 92 to execute the program. The CPU 91 thus implements functions of the image acquisition unit 11, the cell region extraction unit 12, the first feature value distribution acquisition unit 13, the region division unit 14, the second feature value calculation unit 15, the cell information acquisition unit 16, the trained model acquisition unit 31, the abnormality score calculation unit 41, and the detection unit 42. The CPU 91 also implements functions of the input unit 17 and the output unit 18 by controlling the input device 96 and the output device 97.

The CPU 91 implements a function of the storage unit 19 as well by controlling the HDD 94.

The information processing apparatus 9 may further have a function of controlling operation of the cell culture observation apparatus described above, an incubator for performing cell culture, and the like in accordance with a predetermined program.

The present invention is also achieved by executing the following processing. Specifically, software (program) for achieving the functions of the above-described embodiments by causing a computer (or CPU, MPU, or the like) to execute the software (program) is supplied to a system or an apparatus via a network or various kinds of storage media. Then, the computer (or CPU, MPU, or the like) of the system or the apparatus reads out the program to execute the program. Further, the present invention may be achieved by, for example, a circuit (for example, ASIC) that achieves one or more of the functions.

### Cell Manufacturing Method

A cell manufacturing method according to the present invention is a method of manufacturing a cell based on the information about the state of the cell acquired by the cell information acquisition method according to the present invention described above.

That is, the cell manufacturing method according to the present invention includes a cell state information acquisition step of acquiring the information about the state of the cell through use of the cell information acquisition method described above, and a cell processing step. The cell processing step is a step of carrying out at least any one selected from the group consisting of sorting of a cell, removal of a cell, and transition to the subsequent step in cell manufacturing, based on the information about the states of the cells acquired in the cell state information acquisition step.

For example, in the process of culturing an iPS cell maintaining an undifferentiated state, it is possible to perform such control relating to the cell manufacturing method as to classify colonies in terms of whether each colony is in a differentiated state or in an undifferentiated state based on the third embodiment and remove the colony in a differentiated state from the culture vessel. It is also possible to perform such control relating to the cell manufacturing method as to determine whether or not a colony has a karyotype abnormality, and when the colony has a karyotype abnormality, remove the colony from the culture vessel.

Further, as described in the second embodiment, cell culture observation serving as a control is carried out in advance through use of an appropriate cultured cell sample. After that, it is also preferred to carry out a statistical test based on the second embodiment on the cell image of the cultured cell sample to be manufactured and the cell image of the above-described cultured cell sample. Thus, for example, it can be determined that no cross-contamination or misalignment between samples has occurred in the cell manufacturing facility. It is also possible to control cell manufacturing steps by, for example, determining that a cell is being successfully cultured while maintaining a state as expected or determining whether transition to the subsequent step in cell manufacturing (culture medium replacement, cell harvesting, differentiation induction, or the like) is appropriate or inappropriate.

### Cell Inspection Method

A cell inspection method according to the present invention is a method of inspecting a cell based on the information about the state of the cell acquired by the cell information acquisition method according to the present invention described above.

That is, the cell inspection method according to the present invention includes a cell state information acquisition step of acquiring the information about the state of the cell through use of the cell information acquisition method described above, and a cell inspection step. The cell inspection step is a step of carrying out inspection of a cell based on the information about the states of the cells acquired in the cell state information acquisition step.

For example, as described in the first embodiment, based on the cell information acquisition method according to the present invention, the following information about the state of the cell is acquired. That is, information such as viability or proliferation of a cell, a degree of undifferentiation of a cell, residual states of a foreign gene and a reprogramming factor for iPS cell formation, presence or absence of a karyotype abnormality or a genomic abnormality, production efficiency of a useful substance, and presence or absence of cancerous transformation is acquired. Those pieces of information can be used for evaluation of cell quality and inspection such as determination of presence or absence of a disease.

### EXAMPLE

### Example 1

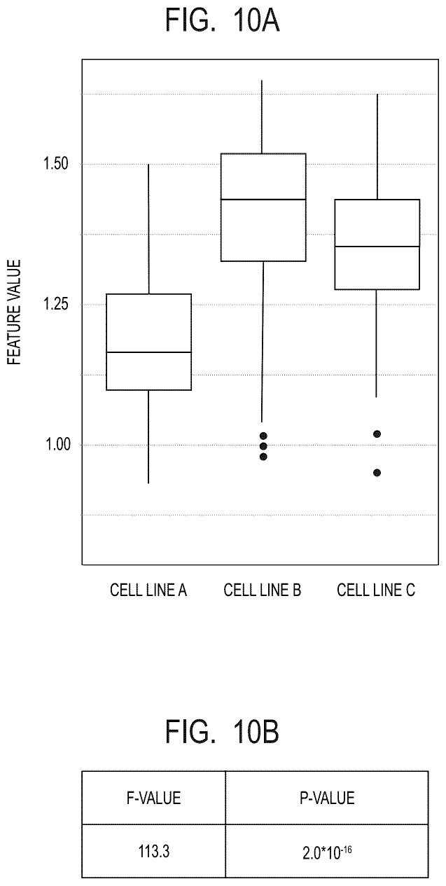

FIG. 10A and FIG. 10B are a box plot and a table, respectively, for showing results obtained in Example 1 in which the second embodiment was applied to culture of an iPS cell line.

In Example 1, cell images in culture of three types of iPS cell lines A, B, and C were acquired, and the second embodiment described above was applied. For the texture feature value in Step S120, a texture feature value distribution of contrast was calculated by the analysis method utilizing the GLCM. Further, in Step S130, the region was divided into the inner region and the outer-edge region by performing the contraction processing so that the area ratio between the inner region and the outer-edge region was 1:1. Further, in Step S140, the average value of the texture feature value of the inner region and the average value of the texture feature value of the outer-edge region were calculated as the second feature value. After that, the statistical test based on analysis of variance was carried out in Step S150.

FIG. 10A is a box plot for showing a distribution of the second feature value of each cell region for each cell line. Meanwhile, FIG. 10B is a table for showing output results of an F-value and the P-value in the analysis of variance.

Those results allow the user to grasp information about what kind of feature distribution the colony of each cell line type has and to what extent there is a difference between the cell line types.

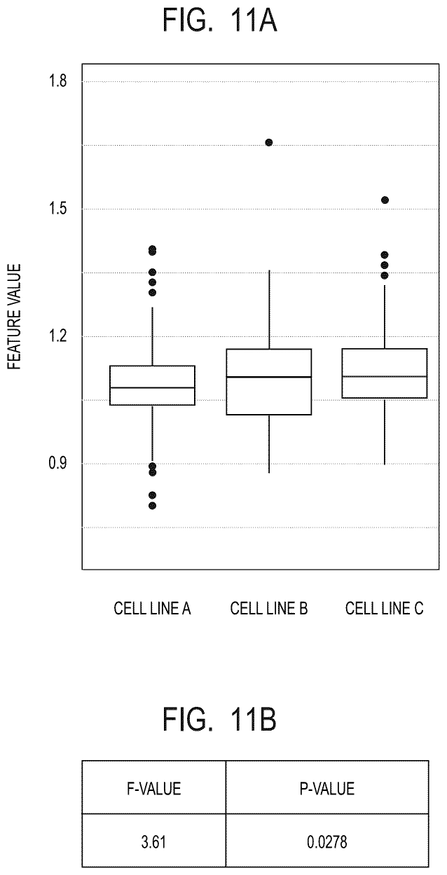

In addition, in acquisition of cell information in Comparative Example 1, cell images in culture of three types of iPS cell lines as in Example 1 were acquired. Further, in the acquisition of the cell information in Comparative Example 1, the analysis of variance was carried out through use of the average value of the texture feature value of an entire cell region without performing the region division in Step S130 and the calculation of the second feature value in Step S140. FIG. 11A is a box plot for showing a distribution of the average value of the texture feature value of the entire cell region for each cell line. Meanwhile, FIG. 11B is a table for showing output results of the F-value and the P-value in the analysis of variance.

As compared to the results shown in FIG. 10A and FIG. 10B, in the results shown in FIG. 11A and FIG. 11B, it is understood that it is difficult for the user to grasp a difference in the state of the cell depending on the cell line type. As described above, from comparison between Example 1 and Comparative Example 1, it is understood that the second feature value calculated in the present invention is a feature value useful for identifying the cell line type.

### Example 2

In Example 2, cell images in culture of three types of iPS cell lines A, B, and C were acquired, and Modification Example 1 of the second embodiment described above was applied. For the texture feature value in Step S120, a plurality of texture feature value distributions based on the GLCM and the frequency characteristic described in Modification Example 1 of the first embodiment were calculated. After that, in Step S130, the region was divided into the inner region and the outer-edge region by performing the contraction processing so that the area ratio between the inner region and the outer-edge region was 1:1. Further, in Step S140, the ratio between the statistical value of the texture feature value of the inner region and the statistical value of the texture feature value of the outer-edge region was calculated as the second feature value. The average value and the coefficient of variation (CV value) are used as the statistical value. Further, the morphological feature value described in Modification Example 5 of the first embodiment was integrated with the second feature value, and the resultant was used as input to the principal component analysis in Step S150.

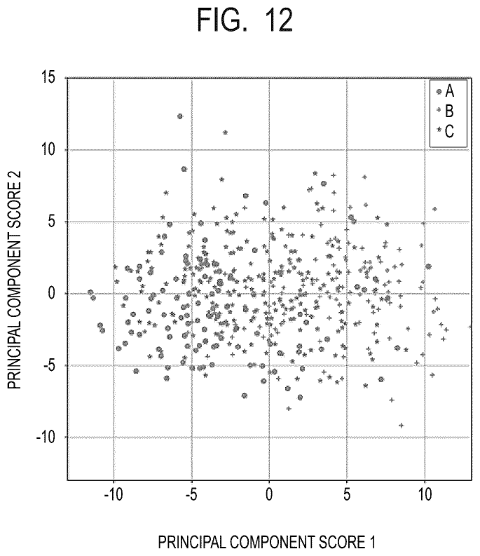

FIG. 12 is a scatter plot in which, with respect to the results obtained in Example 2, respective pieces of input data are plotted with a principal component score 1 plotted on the horizontal axis and a principal component score 2 plotted on the vertical axis. Those results allow the user to grasp information about what kind of feature distribution the colony of each cell line type has and to what extent there is a difference between the cell line types.

In acquisition of cell information in Comparative Example 2, cell images in culture of three types of iPS cell lines as in Example 2 were acquired. In the acquisition of the cell information in Comparative Example 2, principal component analysis was carried out through use of the average value of the texture feature value of an entire cell region and the morphological feature value without performing the region division in Step S130 and the calculation of the second feature value in Step S140.

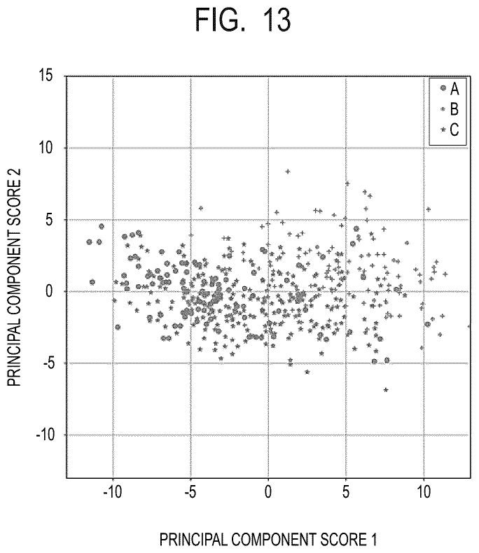

FIG. 13 is a scatter plot in which, with respect to the results obtained in Comparative Example 2, respective pieces of input data are plotted with a principal component score 1 plotted on the horizontal axis and a principal component score 2 plotted on the vertical axis. As compared to the results shown in FIG. 12, in FIG. 13, it is understood that it is difficult for the user to grasp a difference in the state of the cell depending on the cell line type. As described above, from comparison between Example 2 and Comparative Example 2, it is understood that the second feature value calculated in the present invention is a feature value useful for identifying the cell line type.

Any one of the embodiments and Examples described above is merely an example of implementation for carrying out the present invention, and the technical scope of the present invention is not to be construed in a limiting manner due to those embodiments and Examples. That is, the present invention can be carried out in various forms without departing from the technical idea of the invention or major features of the invention. For example, an embodiment in which a configuration of a part of any one of the embodiments is added to another embodiment or an embodiment in which a configuration of a part of any one of the embodiments is substituted with a configuration of a part of another embodiment is also to be understood as an embodiment to which the present invention is applicable.

According to the disclosure of the present specification, a cell information acquisition method capable of evaluating a cell type or a state of a cell for an entire cell region is provided.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168648, filed Sep. 28, 2023, which is hereby incorporated by reference herein in its entirety.

What is claimed is:

1. A cell information acquisition method comprising:
an image acquisition step of acquiring a cell image including an image of a cell aggregation;
a cell region extraction step of extracting at least one cell region from the cell image data, where each cell region corresponds to a cell aggregate;
a first feature value distribution acquisition step of calculating a texture feature value serving as a first feature value for pixels within the cell region, and acquiring a distribution of the first feature value in the cell region;
a region division step of dividing the cell region into two or more divided regions;
a second feature value calculation step of calculating a statistical value of the first feature value distribution for each divided region, and calculating a second feature value indicating a relationship of the statistical values of the first feature value distribution among the divided regions; and
a cell information acquisition step of acquiring one of information about a cell type or a state of cells based on the second feature value.

2. The cell information acquisition method according to claim 1, wherein the region division step includes dividing the cell region based on one of an area of the cell region, a distance from a center-of-gravity of the cell region, or the distribution of the first feature value.

3. The cell information acquisition method according to claim 1, wherein the second feature value calculation step includes calculating one of a difference or a ratio of the statistical value of the first feature value distribution among the divided regions.

4. The cell information acquisition method according to claim 1, wherein the second feature value calculation step includes calculating one of a variance, a standard deviation, or a coefficient of variation (CV value) of the statistical value of the first feature value distribution among the divided regions.

5. The cell information acquisition method according to claim 1,
wherein the number of cell regions to be extracted in the cell region extraction step is three or more, and
wherein the cell information acquisition step includes acquiring a clustering result of clustering the cell regions into two or more clusters.

6. The cell information acquisition method according to claim 1, wherein the cell information acquisition step includes acquiring a result of analyzing, through principal component analysis, a two- or more-dimensional feature value vector including the second feature value.

7. The cell information acquisition method according to claim 1,
wherein the image acquisition step includes acquiring two or more cell images different from one another, and
wherein the cell information acquisition step includes statistically analyzing differences among the second feature values calculated from the respective two or more cell images.

8. The cell information acquisition method according to claim 1, further comprising a trained model acquisition step of acquiring a trained model subjected to machine learning through use of the second feature value and one of the information about the cell type or the information about the state of the cell,
wherein the cell information acquisition step includes using the trained model.

9. The cell information acquisition method according to claim 8, wherein the information about the state of the cell includes at least any one selected from the group consisting of viability, proliferation, a degree of undifferentiation, a residual state of a foreign gene, presence or absence of a genomic abnormality, production efficiency of a useful substance, presence or absence of cancerous transformation, and information about whether transition to a subsequent step in cell manufacturing is appropriate or inappropriate.

10. The cell information acquisition method according to claim 1, wherein cells that form the cell aggregation comprise pluripotent stem cells.

11. The cell information acquisition method according to claim 1, wherein the information about the cell type includes information indicating a cell line type of cells that form the cell aggregation.

12. A cell manufacturing method comprising:
a cell state information acquisition step of acquiring the information about a state of a cell through use of the cell information acquisition method of claim 1; and
a cell processing step of carrying out at least any one selected from the group consisting of sorting of a cell, removal of a cell, and transition to a subsequent step in cell manufacturing, based on the information about the state of the cell acquired in the cell state information acquisition step.

13. A cell inspection method comprising:
a cell state information acquisition step of acquiring the information about a state of a cell through use of the cell information acquisition method of claim 1; and
a cell inspection step of carrying out inspection of the cell based on the information about the state of the cell acquired in the cell state information acquisition step.

14. A cell abnormality detection method comprising:
an image acquisition step of acquiring a cell image including an image of a cell aggregation;
a cell region extraction step of extracting at least one cell region from the cell image data, where each cell region corresponds to a cell aggregate;
a first feature value distribution acquisition step of calculating a texture feature value serving as a first feature value for pixels within the cell region, and acquiring a distribution of the first feature value in the cell region;
a region division step of dividing the cell region into two or more divided regions;
a second feature value calculation step of calculating a statistical value of the first feature value distribution for each divided region, and calculating a second feature value indicating a relationship of the statistical values of the first feature value distribution among the divided regions;
a trained model acquisition step of acquiring a trained model that has machine-learned a probability of occurrence of the second feature value through use of a data group of the second feature values obtained from a plurality of the cell images prepared for machine learning;
an abnormality score calculation step of inputting, to the trained model, the second feature value obtained from the cell image to be evaluated, and calculating an abnormality score based on an output probability; and
a detection step of detecting an abnormality of the cell aggregation based on the abnormality score.

15. A cell information acquisition apparatus comprising:
an image acquisition unit configured to acquire a cell image including an image of a cell aggregation;
a cell region extraction unit configured to extract at least one cell region from the cell image data, where each cell region corresponds to a cell aggregate;
a first feature value distribution acquisition unit configured to calculate a texture feature value serving as a first feature value for pixels within the cell region, and acquire a distribution of the first feature value in the cell region;
a region division unit configured to divide the cell region into two or more divided regions;
a second feature value calculation unit configured to calculate a statistical value of the first feature value distribution for each divided region, and calculate a second feature value indicating a relationship of the statistical values of the first feature value distribution among the divided regions; and
a cell information acquisition unit configured to acquire one of information about a cell type or a state of a cell based on the second feature value.

16. A non-transitory recording medium having recorded thereon a program for causing a computer to execute the cell information acquisition method of claim 1.

17. A non-transitory recording medium having recorded thereon a program for causing a computer to execute the cell abnormality detection method of claim 14.
